(19) United States
(12) Patent Application Publication
(10) Pub. No.: US 2003/0189974 A1
(43) Pub. Date: Oct. 9, 2003

(54) Wireless full-duplex transmission system

(76) Inventor: Chester Ferry, Pleasant Grove., UT (US)

Correspondence Address: PILLSBURY WINTHROP, LLP, P.O. BOX 10500, MCLEAN, VA, 22102, US

(21) Appl. No.: 09/847,581

(22) Filed: May 3, 2001

(51) Int. Cl. H04B 1/38; H04L 5/16

(52) U.S. Cl. 375/219

(57) ABSTRACT

A wireless transmission system and method for supporting the full-duplex transmission of baseband data within a single RF band, is presented herein. The system includes a modem that modulates the baseband data with a spectrally efficient modulation technique. The system also includes a transceiver that accommodates the wireless transmission of data within a first sub-band of frequencies derived from the single RF band and the wireless reception of data within a second sub-band of frequencies derived from the single RF band. The system further includes combline band-pass filters and a dual orthogonal feed antenna to ensure the isolation and separation between the first and second sub-bands.

### BACKGROUND OF THE INVENTION

1. Reservation of Copyright

The disclosure of this patent document contains material, which is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever.

2. Field of the Invention

Aspects of the invention relate to data transmission links, including wireless links.

3. Description of Background Information

Recent advances in computer and cellular technologies, as well as the unprecedented growth of Internet-related applications, have resulted in placing great demands on conventional communication infrastructures to convey information at higher transmission rates with increased reliability. As such, virtually all communication networks, including smaller local area networks (LANs), enterprise networks, and wide area networks (WANs) are subject to these demands.

Generally, conventional communication infrastructures are configured to aggregate traffic at a networked hub and transport the aggregated traffic to another networked hub via full-duplex wireline transmission facilities. Typically, these wireline transmission facilities are configured to accommodate standardized transmission rates of 45 Mbps (e.g.,DS-3), 100 Mbps (e.g., 100BaseT), 155 Mbps (e.g., OC-3), or higher.

In certain geographical areas, wireline transmission facilities may be too impractical or cost prohibitive to implement. For such areas, communication infrastructures may employ wireless broadband transmission systems to wirelessly transport the aggregated traffic between networked hubs. Such wireless transmission systems generally comprise a microwave line-of-sight (LOS) link, operating at certain prescribed transmit/receive radio-frequencies (RF) and associated power levels. The prescribed RF bands and associated power levels are regulated by the Federal Communications Commission (FCC).

To accommodate the full-duplex transmission of data, existing wireless transmission systems operate in half-duplex mode in each direction simultaneously. That is, in one direction, wireless transmissions are transmitted/received at a select carrier frequency within a prescribed RF band and, in the reverse direction, the transmissions are transmitted/received at a select carrier frequency within another prescribed RF band. In this manner, there exists sufficient isolation between the two select carrier frequencies to ensure proper transmission and reception operations in both directions.

As a consequence, conventional wireless transmission systems are generally limited in their ability to span distances between networked hubs that are greater than the distances achievable under FCC regulations. Often, conventional wireless transmission systems rely on repeater and regeneration technology to wirelessly traverse across the necessary distances, thereby increasing operational costs.

Moreover, conventional wireless transmission systems incorporate redundancy measures to protect against equipment failure, minimize down-time, and to ensure a desired level of service. To this end, many wireless transmission systems employ two pairs of separate RF bands. One pair of the RF bands is actively used to transport broadband data while the other RF band pair remains idle until needed. Such redundancy may involve duplication of resources and equipment, further increasing operational costs.

### SUMMARY OF THE INVENTION

Systems and methods consistent with the principles of the present invention, as embodied and broadly described herein, provide for wireless transmission system capable of supporting the full-duplex transmission of baseband data within a single frequency range.

In one embodiment, the wireless transmission system includes a modem configured to modulate the baseband data in accordance with a spectrally efficient modulation technique for generating modulated baseband data signals and to demodulate modulated baseband data signals into baseband data. A transmit mechanism, operatively coupled to the modem, is configured to convert the modulated baseband data signals into transmit radio-frequency signals. The transmit radio-frequency signals operate within a first sub-band of frequencies derived from the single frequency range and contain a carrier frequency centered in the first sub-band of frequencies. A transmit radio-frequency bandpass filter, operatively coupled to the transmit mechanism, is configured to filter the transmit radio-frequency signals within the first sub-band of frequencies. The transmit radio-frequency band-pass filter comprises a narrowband filter having response characteristics that substantially rejects signals outside the first sub-band of frequencies.

The system further includes an antenna mechanism, operatively coupled to the transmit radio-frequency band-pass filter, and configured to radiate the transmit radio-frequency signals and to collect receive radio-frequency signals. A receive mechanism, coupled to the modem, is configured to convert the receive radio-frequency signals into modulated baseband data signals. The receive radio-frequency signals operate within a second sub-band of frequencies derived from the single frequency range and contain a -carrier frequency centered in the second sub-band of frequencies. A receive radio-frequency band-pass filter, operatively coupled to the receive mechanism and antenna mechanism, is configured to filter the receive radio-frequency signals within the second sub-band of frequencies. The receive radio-frequency band-pass filter comprises a narrowband filter having response characteristics that substantially reject signals outside the second sub-band of frequencies.

### BRIEF DESCRIPTION OF THE DRAWINGS

The accompanying drawings, which are incorporated in and constitute a part of this Specification, illustrate an embodiment of the invention. In the drawings:

FIG. 1A is a functional block diagram depicting a wireless full-duplex transmission system, in accordance with an embodiment of the present invention.

FIG. 1B is a functional block diagram depicting a transceiver, in accordance with an embodiment of the present invention.

### DETAILED DESCRIPTION

The following detailed description of the present invention refers to the accompanying drawings that illustrate exemplary embodiments consistent with this invention. Other embodiments are possible and modifications may be made to the embodiments without departing from the spirit and scope of the invention. Therefore, the following detailed description is not meant to limit the invention. Rather the scope of the invention is defined by the appended claims.

The embodiments described below may, instead, be implemented in many different embodiments of software, firmware, and hardware in the entities illustrated in the figures. The actual software code or specialized control hardware used to implement the present invention is not limiting of the present invention. Thus, the operation and behavior of the present invention will be described with the understanding that modification and variations of the embodiments are possible, given the level of detail present herein.

As noted above, wireless transmission systems are required to operate within paired RF bands and associated power levels prescribed by the FCC. (See, e.g., Federal Communications Commission 47 C.F.R. §15.215-15.407). The assignment of RF bands and power levels depend, in part, on whether the wireless transmission operation is licensed or unlicensed (e.g., Unlicensed National Information Infrastructure —U-NII). Typically, fill-duplex wireless transmissions are achieved by operating in half-duplex mode in each direction simultaneously. As described above, in one direction, data is wirelessly transported at a select carrier frequency within one RF band while, in the reverse direction, data is wirelessly transported at a select carrier frequency within another RF band. In this manner, there exists sufficient isolation between the two select carrier frequencies to ensure proper transmission and reception operations in both directions.

As will be described in greater detail below, a wireless transmission system may be employed to provide full-duplex transmissions within a single RF band. Such a configuration exploits differences in prescribed power levels between the paired RF bands to achieve greater transmission distances and allows for built-in redundancy between paired RF bands.

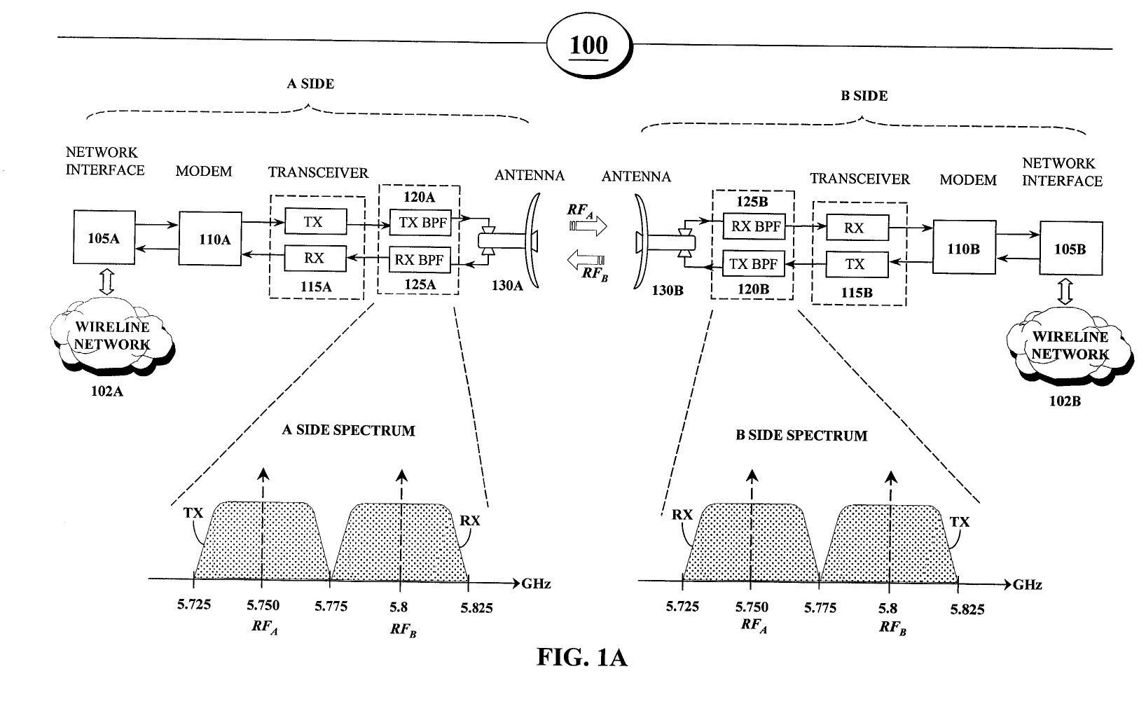

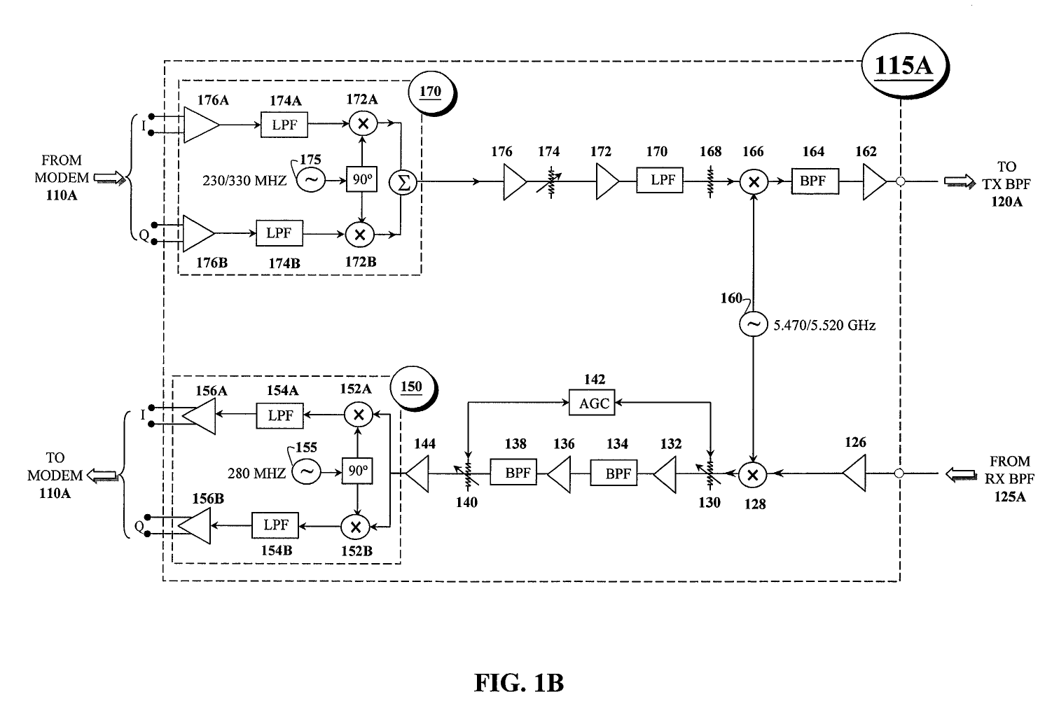

FIG. 1A illustrates a wireless transmission system 100, constructed and operative in accordance with an embodiment of the present invention. As noted above, wireless system 100 achieves full-duplex transmission within a single RF band typically dedicated for half-duplex operations. As indicated in FIG. 1A, wireless system 100 comprises network interface devices 105A, 105B, modems 110A, 110B, transceivers 115A, 115B, transmit RF band-pass filters 120A, 120B, receive RF band-pass filters 125A, 125B and dual-feed microwave antennas 130A, 130B.

Network interface devices 105A, 105B are configured to operatively couple wireless system 100 with wireline networks 102A, 102B conveying aggregated data traffic. It will be appreciated that the aggregated data traffic comprises information-bearing (baseband data) signals, which may be configured in accordance with standardized transmission rates of 45 Mbps (e.g.,DS-3), 100 Mbps (e.g., 100BaseT), and 155 Mbps (e.g., OC-3).

Along the transmit path, modems 110A, 110B are configured to modulate the baseband data signals received from network interface devices 105A, 105B into a form suitable for subsequent RF processing by transceivers 115A, 115B. In one implementation, system 100 may employ, for example, 64-level Quadrature Amplitude Modulation (QAM), which modulates the phase and amplitude attributes of the baseband data signals. It will be appreciated that such a modulation technique is known for its spectral efficiency, capable of accommodating larger amounts of data signals within a predetermined frequency bandwidth. Commensurately, along the receive path, modems 110A, 110B are configured to demodulate signals processed by transceivers 115A, 115B into baseband data signals to be coupled into wireline networks 102A, 102B via network interface devices 105A, 105B.

Along the transmit path, transceivers 115A, 115B are configured to receive the modulated signals from modems 110A, 110B and up-convert the modulated signals into an RF transmit signal capable of being wirelessly transmitted at a predetermined transmit RF carrier frequency. Along the receive path, transceivers 115A, 115B are configured to receive the RF receive signal at a predetermined receive RF carrier frequency and down convert the RF signal into a modulated signal to be demodulated by modems 110A, 110B. As will be described in greater detail below, system 100 operates in full-duplex mode within the same RF band. As such, the RF transmit signal bandwidth operates within a first sub-band of frequencies within the RF band, which includes the transmit RF carrier frequency as the first sub-band center frequency. Similarly, the RF receive signal bandwidth operates within a second sub-band of frequencies within the RF band, which includes the receive RF carrier frequency as the second sub-band center frequency.

Along the transmit path, transmit RF band-pass filters 120A, 120B are configured to filter the RF transmit signals at the transmit RF carrier frequency prior to transmission. Similarly, along the receive path, receive RF band-pass filters 125A, 125B are configured to filter the RF receive signals at the receive RF carrier frequency for subsequent processing. Because system 100 operates in full-duplex mode within the same RF band, sufficient isolation between the respective transmit and receive RF carrier frequencies is required. Accordingly, transmit RF band-pass filters 120A, 120B and receive RF band-pass filters 125A, 125B are configured as narrowband filters capable of providing the isolation between the RF carrier frequencies operating within the same band. In a representative implementation, system 100 may employ combline filters to achieve necessary isolation and narrowband performance. Combline filters are fixed-tuned, narrowband filters comprising a series of parallel-coupled transverse electro-magnetic resonators (e.g., poles). The bandwidth and response of combline filters are a function of resonator size, resonator spacing and ground plane separation.

Dual-feed microwave antennas 130A, 130B are configured to radiate the RF transmission signals at the transmit RF carrier frequency and collect the RF receive signals at the receive RF carrier frequency. In a representative implementation, microwave antennas 130A, 130B are configured as dual orthogonal feed antennas capable of accommodating two orthogonal polarization orientations (e.g., horizontal polarization and vertical polarization). Such a configuration allows for further isolation between the RF carrier frequencies operating within the same band.

In the illustrated embodiment, system 100 incorporates a dual orthogonal feed antenna 130A, 130B as well as narrowband transmit and receive RF filters 120A, 120B, 125A, 125B, respectively, to exploit the individual isolation levels afforded by each. By doing so, system 100 ensures that the necessary isolation between the RF carrier frequencies has been achieved. This, in turn, allows for system 100 to achieve greater transmission distances and/or accommodate built-in redundancy between paired RF bands.

By way of illustration, consider the wireless transport of data operating within the U-NII frequency bands of 5.250-5.350 GHz and 5.725-5.825 GHz. For the 5.250-5.350 GHz frequency band, the FCC limits effective radiated power (ERP) to +30 dBm while, for 5.725-5.825 GHz frequency band, the ERP is limited to +53 dBm. Typically, full-duplex wireless transmissions are achieved by simultaneously operating in half-duplex mode in both, the 5.250-5.350 GHz and 5.725-5.825 GHz bands. However, in accordance with an embodiment of the present invention, wireless system 100 is configured to operate in full-duplex mode within the 5.725-5.825 GHz frequency band to exploit the higher ERP and achieve a greater transmission distance. To do so, wireless system 100 carves out two sub-bands within the 5.725-5.825 GHz band (e.g., 5.725-5.775 GHz and 5.775-5.825 GHz) capable of supporting baseband data transmission rates of up to 155 Mbps (OC-3).

As depicted in FIG. 1A, wireless system 100 communicates in one direction (e.g., from A-side to B-side) within the 5.725-5.775 GHz sub-band by operating at a centered, predetermined RF carrier frequency RF_{A} of 5.75 GHz. Similarly, wireless system 100 communicates in the reverse direction (e.g., from B-side to A-side) within the 5.775-5.825 GHz sub-band by operating at a centered, predetermined RF carrier frequency RF_{B} of 5.800 GHz. It will be appreciated that, because wireless system 100 achieves full-duplex transmission within one RF band, system components simultaneously performing transmit and receive functions are designed to have the necessary isolation between the RF carrier frequencies, RF_{A} (5.750 GHz) and RF_{B} (5.800 GHz), to ensure proper full-duplex operations.

Consistent with this embodiment, system 100 is coupled to wireline network 102A supporting baseband data at 100BaseT (e.g., 100 Mbps) or OC-3 (e.g., 155 Mbps) via network interface device 105A. Modem 110A modulates the baseband data into I and Q modulated signals in accordance with 64-level QAM techniques. Modem 110A supplies the I and Q modulated signals to transceiver 115A.

Transceiver 115A receives and up-converts the I and Q modulated signals. FIG. 1B illustrates a functional block diagram of transceiver 115A, including the functional transmit and receive chains, in accordance with an embodiment of the present invention. Along the transmit chain, transceiver 115A comprises an IQ modulator mechanism 170 and a series of up-converting elements, including attenuators 168, 174, an up-converting mixer 166 and power amplifier 162. IQ modulator mechanism 170 receives the I and Q modulated signals from modem 110A and performs a double-balanced mixing operation, which combines the modulated signals to produce an intermediate frequency (IF) signal.

The IF signal is initially amplified by IF amplifier 176, attenuated by variable attenuator 174 to provide gain control, and amplified again by IF amplifier 172. Low-pass filter (LPF) 170 filters the IF signal to remove any unwanted higher-order harmonics and attenuator 168 attenuates the IF signal to control the gain. Up-converting mixer 166, which is driven by oscillator 160, converts the IF signal into an RF signal having an RF carrier frequency RF_{A} of 5.750 GHz. The RF signal is then filtered by band-pass filter (BFP) 164 to remove any unwanted harmonics and supplied to power amplifier 162 for the final amplification stage. The amplified RF signal is then fed to RF transmit band-pass filter 120A.

As noted above, RF transmit band-pass filter 120A may comprise a narrowband combline filter to achieve the necessary isolation between the RF carrier frequencies, RF_{A} (5.750 GHz) and RF_{B} (5.800 GHz), respectively. In one implementation, RF transmit band-pass filter 120A is configured as a tuned 5- or 7-pole combline filter capable of providing up to 40 dB of separation between RF_{A} and RF_{B}. The band-pass filtered RF transmit signal is subsequently fed to dual-feed microwave antenna 130A.

Dual-feed microwave antenna 130A radiates the RF transmit signal at the RF carrier frequency RF_{A} of 5.750 GHz. As noted above, microwave antennas 130A may be configured as dual orthogonal feed antenna, which is capable of transmitting the RF transmit signal along a predetermined polarization orientations, thereby providing up to an additional 30 dB of isolation between RF_{A} and RF_{B}.

On the other side of the wireless link (e.g., B-side), the polarized RF transmit signal operating at RF_{A} of 5.750 GHz is received by dual-feed microwave antenna 130B. For the sake of brevity, a thorough description of the receive operations of wireless system 100 will be presented with respect to the A-side of system 100, which functions identically to the B-side, except for the use of a different RF carrier frequency. Suffice to say that, on the B-side, the RF receive signal is filtered by RF receive band-pass filter 125B, having a center RF frequency of RF_{A} of 5.750 GHz, to filter any unwanted signals or interference. The filtered RF receive signal is supplied to transceiver 115B, which down-converts the RF receive signal into a QAM-modulated signal having I and Q components. Modem 110B then demodulates the QAM-modulated signal into a baseband signal suitable for coupling into wireline network 102B via network interface 105B.

Dual-feed microwave antenna 130A is also configured to collect the polarized RF signal, operating at the RF carrier frequency RF_{B} of 5.800 GHz, during B-side to A-side transmissions. As noted above, the polarization of the RF receive signal is orthogonal to the RF transmit signal transmitted by antenna 130A, in order to achieve up to 30 dB of isolation between RF_{A} and RF_{B}. The RF receive signal is then supplied to RF receive band-pass filter 125A, having a center RF frequency RF_{B} of 5.800 GHz, to filter any unwanted signals or interference. RF receive band-pass filter 125A may comprise a tuned 5- or 7-pole combline filter to provide additional isolation and separation between RF_{A} and RF_{B}. The band-pass filtered RF receive signal is then fed to transceiver 115A.

Transceiver 115A receives and down-converts the filtered RF receive signal into a baseband signal. Returning to FIG. 1B, along the receive chain, transceiver 115A subjects the RF receive signal to a low-noise amplifier (LNA) 126 to amplify the signal. The amplified RF receive signal is then supplied to down-converting mixer 128, which is driven by oscillator 160 to convert the RF receive signal into an IF receive signal. The IF receive signal is then fed to a dual-stage filtering and automatic gain control (AGC) unit 142.

Variable attenuator 130, which is operatively coupled to an AGC unit 142, attenuates the IF receive signal to control the gain of the signal. The attenuated IF receive signal is subsequently passed through a dual stage IF amplifier and BPF combination 132, 134 and 136, 138, respectively, to strike a balance between adequate signal-to-noise ratios and a viable dynamic range. In particular IF amplifier 132 amplifies the attenuated IF receive signal and BPF 134 filters the signal to reject any unwanted signals or interference. The IF receive signal is then amplified by IF amplifier 136 to compensate for any loss due to BPF 134 and subsequently filtered by BPF 138. BPFs 134, 138 may comprise surface acoustic wave (SAW) filters. The IF receive signal is then supplied to another variable attenuator 140, which is also coupled to AGC unit 142, to control the gain of the signal and is further amplified by IF amplifier 144.

The IF signal is then fed to IQ demodulator mechanism 150, which performs a double-balanced mixing operation to down-convert the IF signal into I and Q modulated baseband signals. The I and Q modulated baseband signals are supplied to modem 110A, which demodulates the I and Q modulated baseband signals into baseband signals suitable for coupling into wireline network 102A via network interface 105A.

In this manner, wireless system 100 is capable of servicing up to 155 Mbps of data in full-duplex mode while operating within the 5.725-5.825 GHz frequency band. Such a capability exploits the higher ERP afforded by the 5.725-5.825 GHz frequency band to achieve a transmission distance of up to 40 miles, without the use of repeater or regeneration technology.

It will be appreciated that the features and attributes of wireless system 100 may also be used to provide built-in redundancy within a single RF band. For example, instead of employing two RF bands to achieve full-duplex operations, each of the RF bands may be divided into two RF sub-bands to support full-duplex operations, as described above. As such, one of the RF bands may serve as a primary link for active wireless transmissions, while the other RF band may serve as a secondary link and lie in reserve until the primary link experiences a failure.

The foregoing description of the embodiments of the present invention provides illustration and description, but is not intended to be exhaustive or to limit the invention to the precise form disclosed. Modifications and variations are possible consistent with the above teachings or may be acquired from practice of the invention. For example, the various features of the invention, which are described in the contexts of separate embodiments for the purposes of clarity, may also be combined in a single embodiment. Conversely, the various features of the invention which are, for brevity, described in the context of a single embodiment may also be provided separately or in any suitable sub-combination. Accordingly, it will be appreciated by persons skilled in the art that the present invention is not limited to what has been particularly shown and described hereinabove. Rather, the scope of the present invention is defined only by the attached claims and their equivalents.

What is claimed is:

1. A wireless transmission system for supporting the full-duplex transmission of data within a single frequency range, said wireless transmission system comprising:
a modem configured to modulate baseband data to generate modulated baseband data signals and to demodulate modulated baseband data signals into baseband data;
a transmit mechanism operatively coupled to said modem and configured to convert the modulated baseband data signals into transmit radio-frequency signals, wherein the transmit radio-frequency signals operate within a first sub-band of frequencies derived from the single frequency range and contain a carrier frequency centered in said first sub-band of frequencies;
a transmit radio-frequency band-pass filter operatively coupled to said transmit mechanism and configured to filter the transmit radio-frequency signals within said first sub-band of frequencies, said transmit radio-frequency band-pass filter comprising a narrowband filter having response characteristics that substantially reject signals outside said first sub-band of frequencies;
an antenna mechanism operatively coupled to said transmit radio-frequency band-pass filter and configured to radiate the transmit radio-frequency signals and to collect receive radio-frequency signals;
a receive mechanism coupled to said modem and configured to convert the receive radio-frequency signals into modulated baseband data signals, wherein the receive radio-frequency signals operate within a second sub-band of frequencies derived from the single frequency range and contain a carrier frequency centered in said second sub-band of frequencies; and
a receive radio-frequency band-pass filter operatively coupled to said receive mechanism and said antenna mechanism and configured to filter the receive radio-frequency signals within said second sub-band of frequencies, said receive radio-frequency band-pass filter comprising a narrowband filter having response characteristics that substantially reject signals outside said second sub-band of frequencies.

2. The wireless transmission system of claim 1, wherein said antenna mechanism comprises a dual orthogonal feed antenna configured to transmit said transmit radio-frequency signals in accordance with a first polarization orientation and receive said receive radio-frequency signals in accordance with a second polarization orientation, such that said first polarization orientation is orthogonal to said second polarization orientation.

3. The wireless transmission system of claim 1, further comprising a network interface device operatively coupled to said modem and configured to supply baseband data to, and receive baseband data from, said modem.

4. The wireless transmission system of claim 2, wherein at least one of said transmit and receive radio-frequency band-pass filter comprises a combline filter.

5. The wireless transmission system of claim 3, wherein said modem modulates the baseband data in accordance with QAM modulation techniques.

6. The wireless transmission system of claim 5, wherein said transmit mechanism includes,
a modulating mechanism which converts said modulated baseband signals into transmit intermediate-frequency signals,
an up-converting circuit configured to convert said transmit intermediate frequency signals into said transmit radio-frequency signals, and
a power amplifier configured to amplify said transmit radio-frequency signals.

7. The wireless transmission system of claim 6, wherein said receive mechanism includes,
a low-noise amplifier configured to amplify said receive radio-frequency signals,
a down-converting circuit configured to convert said amplified receive radio-frequency signals into receive intermediate frequency signals, and
a demodulating mechanism which converts said receive intermediate frequency signals into said modulated baseband signals.

8. The wireless transmission system of claim 7, further comprising a transceiver, wherein said transmit mechanism and said receive mechanism are incorporated in said transceiver.

9. The wireless transmission system of claim 7, wherein said first sub-band of frequencies comprises 5.725-5.775 GHz and the transmit radio-frequency signals operate with a carrier frequency of 5.750 GHz.

10. The wireless transmission system of claim 9, wherein said second sub-band of frequencies comprises 5.775-5.825 GHz and the receive radio-frequency signals operate with a carrier frequency of 5.800 GHz.

11. A wireless transmission system for supporting the full-duplex transmission of data within a single frequency range, said wireless transmission system comprising:
a transmit radio-frequency band-pass filter configured to filter transmit radio-frequency signals within a first sub-band of frequencies derived from the single frequency range, said transmit radio-frequency band-pass filter comprising a narrowband filter having response characteristics that substantially reject signals outside said first sub-band of frequencies;
a receive radio-frequency band-pass filter configured to filter receive radio-frequency signals within a second sub-band of frequencies derived from the single frequency range, said receive radio-frequency band-pass filter comprising a narrowband filter having response characteristics that substantially reject signals outside said second sub-band of frequencies; and
an antenna mechanism operatively coupled to at least one of said transmit and receive radio-frequency band-pass filters and configured to radiate the transmit radio-frequency signals and to collect receive radio-frequency signals,
wherein said antenna mechanism includes a dual orthogonal feed configuration capable of radiating said transmit radio-frequency signals in accordance with a first polarization orientation and collecting said receive radio-frequency signals in accordance with a second polarization orientation, such that said first polarization orientation is orthogonal to said second polarization orientation.

12. The wireless transmission system of claim 11, further including a modem configured to modulate baseband data to generate modulated baseband data signals and to demodulate modulated baseband data signals into baseband data.

13. The wireless transmission system of claim 12, further including a transmit mechanism operatively coupled to said modem and configured to convert the modulated baseband data signals into the transmit radio-frequency signals, wherein the transmit radio-frequency signals operate within said first sub-band of frequencies and contain a carrier frequency centered in said first sub-band of frequencies.

14. The wireless transmission system of claim 13, further including a receive mechanism coupled to said modem and configured to convert the receive radio-frequency signals into modulated baseband data signals, wherein the receive radio-frequency signals operate within said second sub-band of frequencies and contain a carrier frequency centered in said second sub-band of frequencies.

15. The wireless transmission system of claim 14, further comprising a network interface device operatively coupled to said modem and configured to supply baseband data to, and receive baseband data from, said modem.

16. The wireless transmission system of claim 15, wherein at least one of said transmit and receive radio-frequency band-pass filter comprises a combline filter.

17. The wireless transmission system of claim 12, wherein said modem modulates the baseband data in accordance with QAM modulation techniques.

18. The wireless transmission system of claim 13, wherein said transmit mechanism includes,
a modulating mechanism which converts said modulated baseband signals into transmit intermediate-frequency signals,
an up-converting circuit configured to convert said transmit intermediate frequency signals into said transmit radio-frequency signals, and
a power amplifier configured to amplify said transmit radio-frequency signals.

19. The wireless transmission system of claim 14, wherein said receive mechanism includes,
a low-noise amplifier configured to amplify said receive radio-frequency signals,
a down-converting circuit configured to convert said amplified receive radio-frequency signals into receive intermediate frequency signals, and
a demodulating mechanism which converts said receive intermediate frequency signals into said modulated baseband signals.

20. The wireless transmission system of claim 14, further comprising a transceiver, wherein said transmit mechanism and said receive mechanism are incorporated in said transceiver.

21. The wireless transmission system of claim 11, wherein said first sub-band of frequencies comprises 5.725-5.775 GHz and the transmit radio-frequency signals operate with a carrier frequency of 5.750 GHz.

22. The wireless transmission system of claim 11, wherein said second sub-band of frequencies comprises 5.775-5.825 GHz and the receive radio-frequency signals operate with a carrier frequency of 5.800 GHz.
